(19) United States
(12) Patent Application Publication
(10) Pub. No.: US 2015/0077965 A1
(43) Pub. Date: Mar. 19, 2015

(54) STROBE DEVICE AND IMAGE-CAPTURING DEVICE PROVIDED WITH STROBE DEVICE

(71) Applicant: Panasonic Intellectual Property Management Co., Ltd., Osaka (JP)

(72) Inventor: Kazuhiko Ooyama, Hyogo (JP)

(21) Appl. No.: 14/394,768

(22) PCT Filed: Apr. 18, 2013
(86) PCT No.: PCT/JP2013/002612

§ 371 Date: Oct. 16, 2014

(30) Foreign Application Priority Data
Apr. 25, 2012 (JP) 2012-099476

(51) Int. Cl. G03B 15/05; F21V 14/02

(52) U.S. Cl. CPC G03B 15/05; F21V 14/02
USPC 362/3

(57) ABSTRACT

A strobe device according to the present invention includes: a strobe main body; a light-emitting unit rotatably connected to the strobe main body; a variable mechanism capable of changing an angle of the light-emitting unit; a drive unit for driving the variable mechanism; and a control unit for controlling the drive unit, wherein the control unit has a mode of changing an illumination direction angle of the light-emitting unit regularly or irregularly before shooting. This makes it possible, when a subject to be photographed is a human or an animal, to draw the subject's attention, and photograph the subject in a proper state.

### TECHNICAL FIELD

This invention relates to a strobe device which can change an illumination direction of a light-emitting unit (variable illumination direction type strobe device) and to an imaging device equipped with the strobe device.

### BACKGROUND ART

As a conventional technique to obtain a more natural image by using an imaging device, a bounce flash shooting is known. In the bounce flash shooting, a subject is photographed under a condition being indirectly illuminated by diffused light obtained by reflecting strobe light emitted from a light-emitting unit of a strobe device with a reflective body such as a ceiling or wall.

That is, in the bounce flash shooting, a light-emitting plane of the light-emitting unit of the strobe device is not directly faced to the subject, but is faced toward a desired direction in which a reflective body such as a ceiling or a wall exists so that the subject is illuminated by the strobe light reflected by the reflective body and photographed under this illumination condition.

A conventional strobe device having such a configuration has been proposed that a control unit of a strobe device automatically controls the bounce angle made by a shooting direction which is an optical axis direction of an imaging lens and an illumination direction in which strobe light is emitted (a desired direction in which a reflective body exists) (see, for example, PTL1 of Patent Literature). It is possible to always emit strobe light toward a direction in which a reflective body exists, and indirectly illuminate a subject.

According to the strobe device disclosed in PTL1, the imaging lens is pointed at each of the reflective body and the subject to perform autofocus range finding, and a bounce flash angle is set based on the distances to the reflective body and the subject.

Also, when the subject is a human or an animal, regardless of whether or not to perform bounce flash shooting, the photographer often calls the subject before shooting to take a picture of, for example, a vivid expression of the subject.

However, some photographers may feel ashamed to call the subject. Also, when the subject is a small child or an animal like a dog, the subject often may not respond to the photographer's call. Accordingly, there is such a problem that the subject cannot be photographed with a vivid expression.

### CITATION LIST

### Patent Literature

PTL 1: Unexamined Japanese Patent Publication No. 2009-163179

### SUMMARY OF THE INVENTION

To solve the above problem, a strobe device according to the present invention includes: a strobe main body; a light-emitting unit rotatably connected to the strobe main body; a variable mechanism capable of changing an angle of the light-emitting unit; a drive unit for driving the variable mechanism; and a control unit for controlling the drive unit, wherein the control unit has a mode of changing an illumination direction angle of the light-emitting unit regularly or irregularly before shooting.

This strobe device makes it possible, when the subject is a human or an animal, to catch the subject's eye by the operation of the light-emitting unit and to draw attention of the subject (for example, make the subject turn to the imaging device side). As a result, shooting the subject in this state makes it possible to photograph the subject with a vivid expression.

Also, an imaging device according to the present invention is equipped with the above-described strobe device. This makes it possible to realize an imaging device that can draw attention of the subject and photograph the subject with a vivid expression.

### BRIEF DESCRIPTION OF DRAWINGS

FIG. 1 is a block diagram showing a configuration of an imaging device according to an exemplary embodiment of the present invention.

FIG. 2 is a side view of the strobe device according to the exemplary embodiment.

FIG. 3 is a top view of the strobe device according to the exemplary embodiment.

FIG. 4A is a diagram illustrating an illumination range in a vertical direction, which can be set by the strobe device according to the exemplary embodiment.

FIG. 4B is a diagram illustrating an illumination range in a horizontal direction, which can be set by the strobe device according to the exemplary embodiment.

FIG. 5A is a conceptual diagram showing an attention-drawing operation pattern by the strobe device according to the exemplary embodiment.

FIG. 5B is a conceptual diagram showing an attention-drawing operation pattern by the strobe device according to the exemplary embodiment.

FIG. 5C is a conceptual diagram showing an attention-drawing operation pattern by the strobe device according to the exemplary embodiment.

FIG. 5D is a conceptual diagram showing an attention-drawing operation pattern by the strobe device according to the exemplary embodiment.

FIG. 6 is a flowchart illustrating operations of the strobe device according to the exemplary embodiment in a shooting mode having an attention-drawing operation pattern.

### DESCRIPTION OF EMBODIMENT

Hereinafter, a strobe device according to an exemplary embodiment of the present invention and an imaging device equipped with the same will be described with reference to the drawings. It should be noted that the exemplary embodiment described below is an embodied example of the present invention, and is not intended to limit the technical scope of the present invention.

### Exemplary Embodiment

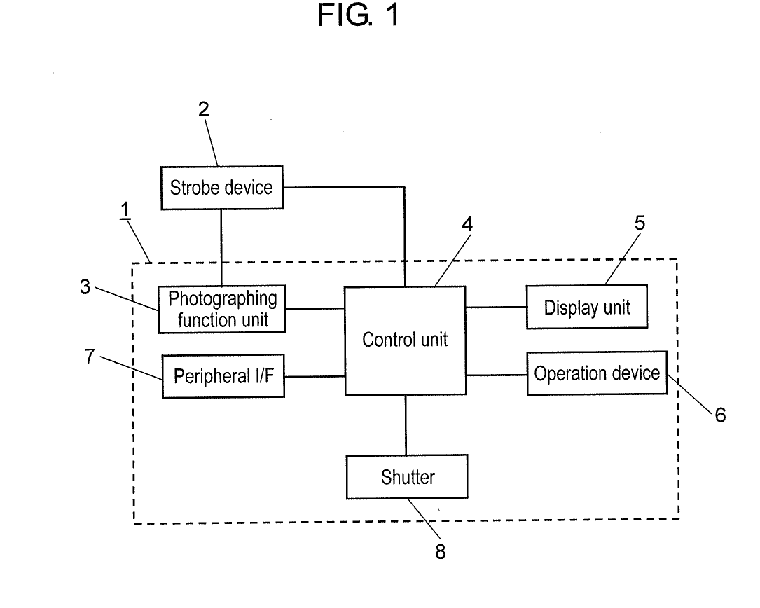

Hereinafter, a strobe device according to an exemplary embodiment of the present invention and an imaging device equipped with the strobe device will be described with reference to FIG. 1 to FIG. 4B.

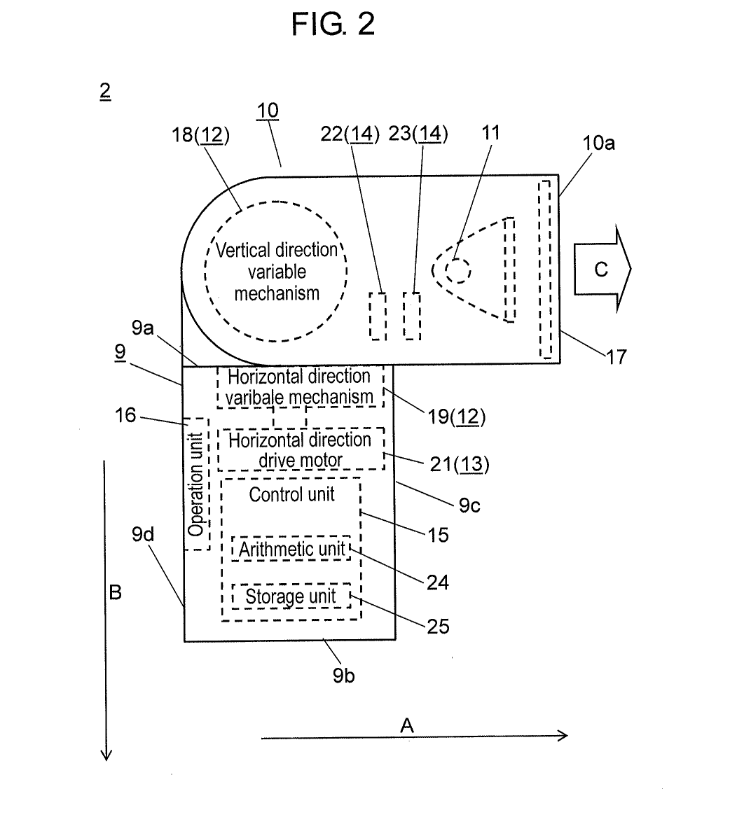

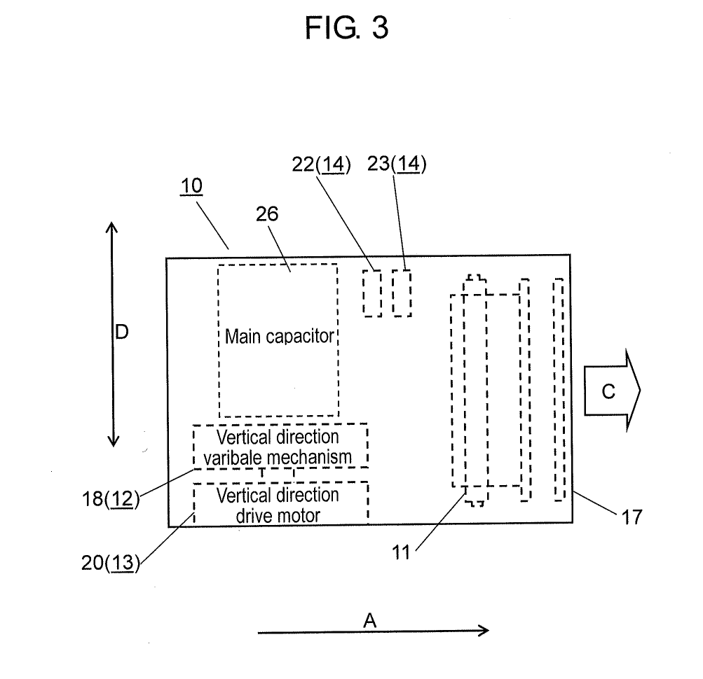

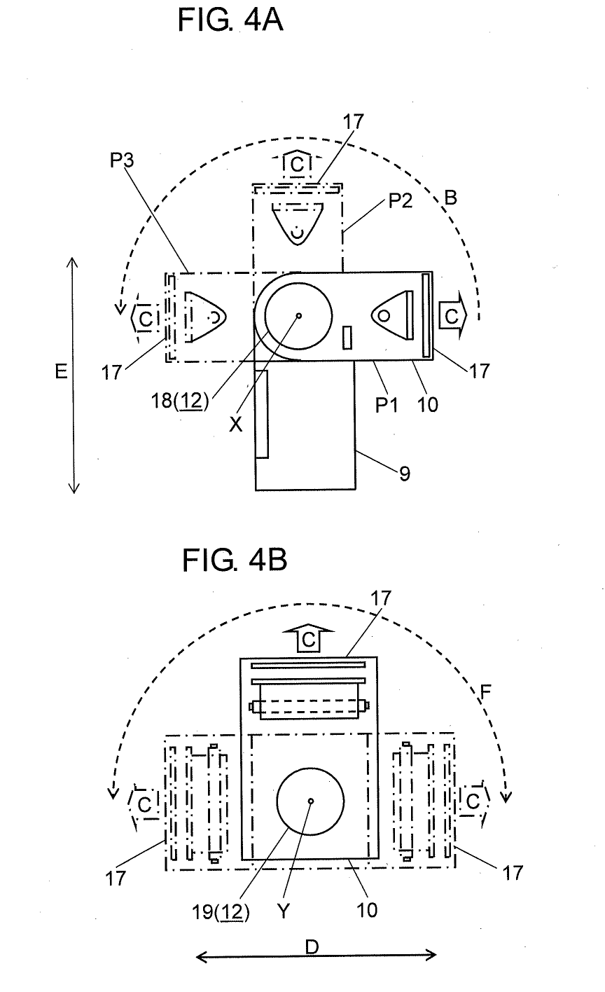

FIG. 1 is a block diagram showing a configuration of an imaging device according to an exemplary embodiment of the present invention. FIG. 2 is a side view of the strobe device according to the exemplary embodiment. FIG. 3 is a top view of the strobe device according to the exemplary embodiment. FIG. 4A is a diagram illustrating an illumination range in a vertical direction, which can be set by the strobe device according to the exemplary embodiment. FIG. 4B is a diagram illustrating an illumination range in a horizontal direction, which can be set by the strobe device according to the exemplary embodiment.

As shown in FIG. 1, imaging device 1 of the present exemplary embodiment has at least photographing function unit 3 for taking an image of a subject, control unit 4, display unit 5, operation device 6, peripheral interface (peripheral I/F) 7, and shutter 8. Further, imaging device 1 is equipped with detachable strobe device 2 for illuminating the subject by strobe light.

Control unit 4 controls strobe device 2 and photographing function unit 3. Display unit 5 displays an image obtained by shooting the subject or other images. Operation device 6 changes settings of shooting conditions and power-on/off state. Peripheral interface 7 performs input and output of image data or other data between imaging device 1 and a peripheral device. Shutter 8 is operated by a user to trigger strobe device 2 to emit light and shoot the subject.

Also, as shown in FIG. 2 and FIG. 3, strobe device 2 of the present exemplary embodiment has at least strobe main body 9 configured by a housing formed in, for example, a rectangular-shape, light-emitting unit 10, variable mechanism 12, drive unit 13, angle detection unit 14, control unit 15, and operation unit 16. Light-emitting unit 10 is rotatably connected to strobe main body 9, and has encased therein flash discharge tube 11. Light-emitting unit 10 enables flash discharge tube 11 to generate light by electric energy supplied from main capacitor 26, and emits the generated light outward. Variable mechanism 12 changes an angle of light-emitting unit 10 to a specified angle. Drive unit 13 drives variable mechanism 12. Angle detection unit 14 detects an angle of light-emitting unit 10 relative to strobe main body 9. Control unit 15 controls strobe device 2. Operation unit 16 is provided, for example, on back surface 9d of strobe main body 9, and performs input of various setting values and selection of various modes. Also, light-emitting unit 10 is rotatably connected to strobe main body 9 at top surface 9a of strobe main body 9. In addition, strobe main body 9 is connected at lower surface 9b thereof to imaging device 1 shown in FIG. 1. At this time, strobe main body 9 is connected to imaging device 1 so that front surface 9c of strobe main body 9 faces in shooting direction A (an optical axis direction of an imaging lens) of imaging device 1.

Also, light-emitting unit 10 is configured by a housing formed, for example, in an approximately rectangular-shape (including a rectangular-shape), and is provided at one surface 10a of the housing with opening 17 for emitting light generated by flash discharge tube 11. Light-emitting unit 10 is configured so that illumination direction C in which strobe light is emitted can be changed by changing an angle of opening 17 relative to vertical direction B.

Also, variable mechanism 12 is configured, as shown in FIG. 4A and FIG. 4B, by vertical direction variable mechanism 18 and horizontal direction variable mechanism 19, and rotatably connects strobe main body 9 and light-emitting unit 10. Specifically, vertical direction variable mechanism 18 of variable mechanism 12 is connected so as to be rotatable in vertical direction B about horizontal shaft X disposed along width direction D of strobe main body 9 (see FIG. 3). On the other hand, horizontal direction variable mechanism 19 of variable mechanism 12 is connected so as to be rotatable in horizontal direction F about vertical shaft Y disposed in vertical direction E of strobe main body 9 (height direction: see FIG. 4A).

Further, vertical direction variable mechanism 18 of variable mechanism 12 is disposed, as shown in FIG. 4A, so as to be capable of changing an angle of light-emitting unit 10 in vertical direction B. Specifically, vertical direction variable mechanism 18 is disposed to rotatably connect light-emitting unit 10 with strobe main body 9 so that an angle of light-emitting unit 10 can be changed in vertical direction B within a range including a normal illumination direction angle (an angle at which light-emitting unit 10 is in normal shooting position P1 as indicated by solid lines in FIG. 4A) and a desired illumination direction angle (an angle at which light-emitting unit 10 is in bounce flash shooting position P2 or P3 as indicated by dashed lines in FIG. 4A) which is set by a user and is different from the normal illumination direction angle. In the present exemplary embodiment, vertical direction variable mechanism 18 of variable mechanism 12 is rotatable within a rotation angle range of, for example, 180 degrees in vertical direction B between normal photography position P1 and bounce flash shooting position P3.

On the other hand, horizontal direction variable mechanism 19 of variable mechanism 12 is disposed, as shown in FIG. 4B, so as to be capable of changing an angle of light-emitting unit 10 in horizontal direction F. In the present exemplary embodiment, horizontal direction variable mechanism 19 is rotatable rightward or leftward in a rotation angle range of 180 degrees.

Also, drive unit 13 has, as shown in FIG. 2 and FIG. 3, vertical direction drive unit 20 (see FIG. 3) including a vertical direction drive motor for rotationally driving vertical direction variable mechanism 18, and horizontal direction drive unit 21 (see FIG. 2) including a horizontal direction drive motor for rotationally driving horizontal direction variable mechanism 19.

Also, angle detection unit 14 is provided in light-emitting unit 10, and has vertical direction angle detection unit 22 for detecting an angle of light-emitting unit 10 in vertical direction B, and horizontal direction angle detection unit 23 for detecting an angle of light-emitting unit 10 in horizontal direction F. In the present exemplary embodiment, each of vertical direction angle detection unit 22 and horizontal direction angle detection unit 23 is configured, for example, by a potentiometer. Each of an inclination angle of light-emitting unit 10 in vertical direction B and an inclination angle of light-emitting unit 10 in horizontal direction F is detected from a voltage dependent on a rotation angle of the potentiometer.

Also, control unit 15 has arithmetic unit 24 for performing various arithmetic operations, and storage unit 25 for storing various modes and various information including attention-drawing operation patterns corresponding to respective modes which will be described later. Control unit 15 is configured by a CPU (Central Processing Unit), and storage unit 25 is configured by a RAM (Random Access Memory) or ROM (Read-Only Memory) incorporated in the CPU or a RAM or ROM externally connected to the CPU. The mode may include, for example, a shooting mode having an attention-drawing operation pattern.

Strobe device 2 of the present exemplary embodiment and imaging device 1 equipped with strobe device 2 are configured as described above.

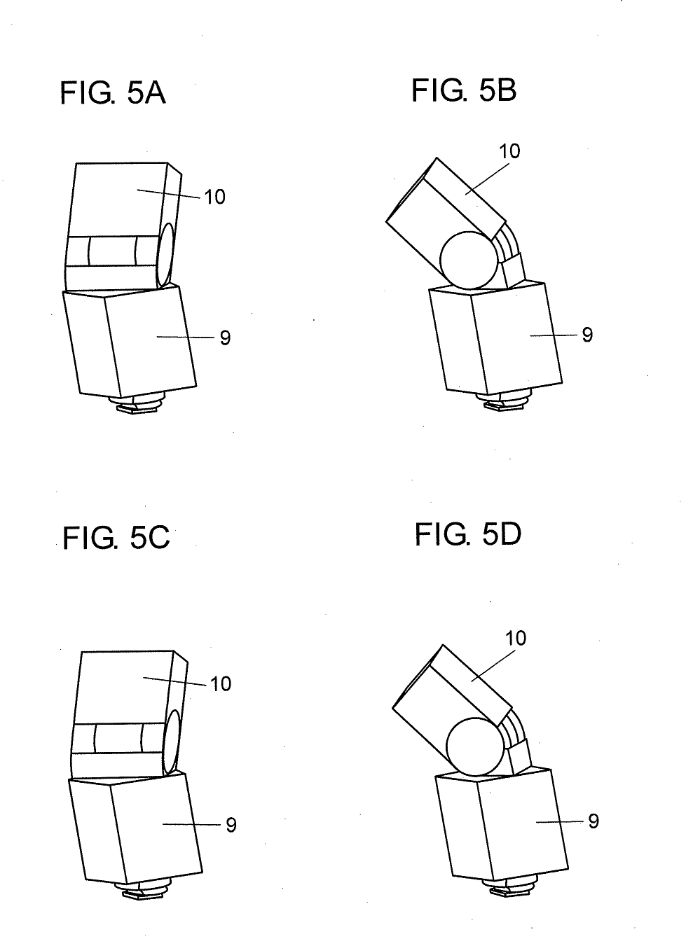

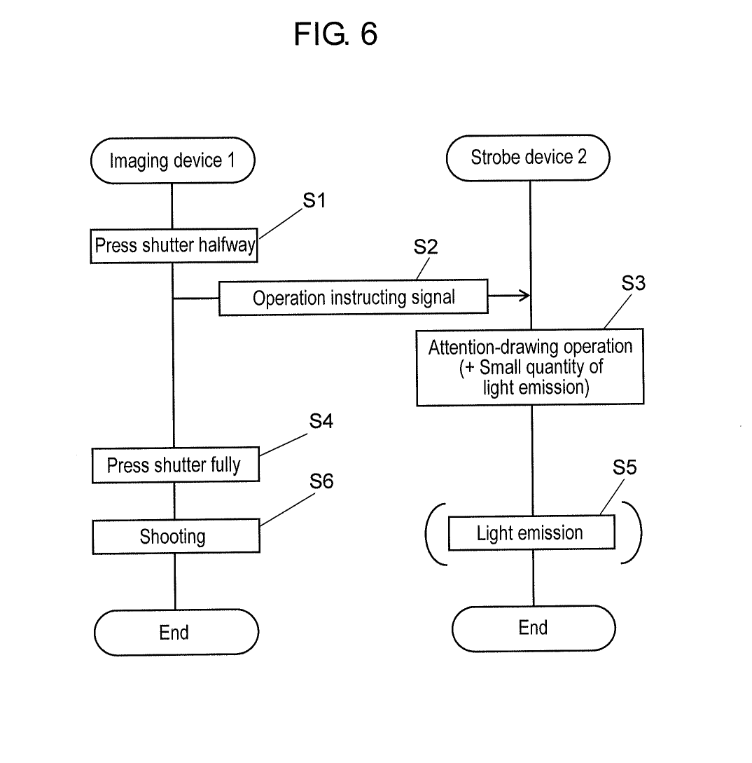

Hereinafter, operations of an imaging device according to the exemplary embodiment in a shooting mode having an attention-drawing operation pattern will be described with reference to FIG. 5A to FIG. 6.

Each of FIG. 5A to FIG. 5D is a conceptual diagram showing an attention-drawing operation pattern of the strobe device according to the exemplary embodiment.

Here, the shooting mode having an attention-drawing operation pattern is a mode in which shutter 8 is kept in a state being pressed halfway prior to a fully pressed state, which is a trigger to start a shooting process, and the strobe device 2 performs, in this state, an operation of regularly changing an illumination direction angle of light-emitting unit 10 (an attention-drawing operation).

Accordingly, in order to perform the attention-drawing operation, control unit 15 of strobe device 2 of the present exemplary embodiment has a mode of regularly changing the illumination direction angle of light-emitting unit 10.

To perform this operation, storage unit 25 of control unit 15 of strobe device 2 has stored therein in advance, for example, four attention-drawing operation patterns for changing the illumination direction angle of light-emitting unit 10 as shown in FIG. 5A to FIG. 5D. Specifically, the attention-drawing operation patterns are set, for example, by inputting angle information by programming, and stored in storage unit 25 of control unit 15.

More specifically, the attention-drawing operation patterns include a pattern in which light-emitting unit 10 is in a position facing away upper rightward from the subject (a position in which light-emitting unit 10 becomes at an angle of 45 degrees rightward in horizontal direction F and at an angle of 45 degrees upward in vertical direction B relative to strobe main unit 9) as shown in FIG. 5A and FIG. 5C. Also, the attention-drawing operation patterns include a pattern in which light-emitting unit 10 is in a position facing away upper leftward from the subject (a position in which light-emitting unit 10 becomes at an angle of 45 degrees leftward in horizontal direction F and at an angle of 45 degrees upward in vertical direction B relative to strobe main unit 9) as shown in FIG. 5B and FIG. 5D.

Such a mode is selected that the attention-drawing operation patterns as shown in FIG. 5A to FIG. 5D are repeated a specified number of times. Specifically, in the present exemplary embodiment, the specified number of times is twice, that is, a sequence of the attention-drawing operation patterns from FIG. 5A to FIG. 5D is selected. Incidentally, the above-mentioned “twice” includes a meaning that a sequence of the operation patterns from FIG. 5A to FIG. 5D is repeated twice, and a meaning that a set of FIG. 5A and FIG. 5B and a set of FIG. 5C and FIG. 5D are each executed twice.

Next, operations of the imaging device according to the present exemplary embodiment in a shooting mode having an attention-drawing operation pattern will be described with reference to FIG. 6.

FIG. 6 is a flowchart illustrating operations of the strobe device according to the exemplary embodiment in a shooting mode having an attention-drawing operation pattern.

First, as shown in FIG. 6, a photographer points an imaging lens of imaging device 1 at a subject, and presses shutter 8 halfway (step S1). In response to this operation, control unit 4 of imaging device 1 sends an operation instructing signal to strobe device 2 (step S2).

Next, control unit 15 of strobe device 2 having received the operation instructing signal reads out an attention-drawing operation pattern stored in storage unit 25. According to the attention-drawing operation pattern, control unit 15 of strobe device 2 changes the angle of light-emitting unit 10 relative to strobe main body 9 in vertical direction B and horizontal direction F (step S3). Specifically, control unit 15 of strobe device 2 controls vertical direction drive unit 20 and horizontal direction drive unit 21 of drive unit 13 to drive variable mechanism 12. Accordingly, each of vertical direction variable mechanism 18 and horizontal direction variable mechanism 19 change the angle of light-emitting unit 10 relative to strobe main body 9.

At this time, control unit 15 of strobe device 2 controls light-emitting unit 10 to emit light at each of the positions of strobe device 2 shown in FIG. 5A to FIG. 5D (step S3). This operation (and the light) of light-emitting unit 10 catches the subject's eye and draws the subject's attention.

In the state the subject is looking straight at imaging device 1 (strobe device 2), the photographer may fully press shutter 8 of imaging device 1 (step S4). In this case, imaging device 1 sends a light emission signal (not shown) to strobe device 2.

In response to the light emission signal, control unit 15 of strobe device 2 controls light-emitting unit 10 to emit light (step S5), and at the same time, control unit 4 of imaging device 1 controls photographing function unit 3 to execute a shooting (step S6). In this case, the light emission for attention-drawing in step S3 is preferably in small quantity. This makes it possible to reduce consumption of electrical energy stored in main capacitor 26 of strobe device 2 necessary for light emission of light-emitting unit 10, and to secure a strobe light quantity required for photographing.

According to the shooting mode having an attention-drawing operation pattern of the present exemplary embodiment, the operation and light emission of light-emitting unit 10 catch the subject's eye and draw the subject's attention. Shooting in this state, when the subject is a human or an animal, makes it possible to photograph a vivid expression of the subject. Accordingly, the subject can be photographed in a proper condition.

Incidentally, in the shooting mode having an attention-drawing operation pattern of the present exemplary embodiment, it is not preferable that the time from the start of an operation to the end of the operation (a required time for an attention-drawing operation) becomes long, because of the possibility that the attention of the subject may decrease. Accordingly, the required time for an attention-drawing operation may preferably be, for example, two seconds or shorter per each attention-drawing operation.

In this respect, what accounts for the highest portion of the required time for an attention-drawing operation in the shooting mode having an attention-drawing operation pattern is the time required to change the position, such as the angle, of light-emitting unit 10. Therefore, in order to shorten the required time for an attention-drawing operation, the time required to change the position of light-emitting unit 10 may be reduced.

Accordingly, in the present exemplary embodiment, vertical direction drive unit 20 and horizontal direction drive unit 21 of drive unit 13 respectively drive vertical direction variable mechanism 18 and horizontal direction variable mechanism 19 of variable mechanism 12 so that light-emitting unit 10 moves at a rate of, for example, 180° per second. This makes it possible to shoot before the subject's attention decreases.

Incidentally, it may be needless to say that a strobe device of the present invention and an imaging device equipped with the same are not limited to the above-described exemplary embodiment, and that various changes may be made without departing from the scope of the present invention.

For example, in the exemplary embodiment described above, the combination of four illumination direction angles (two kinds of illumination direction angles) is described as an example of the attention-drawing operation pattern. However, the attention-drawing operation pattern is not limited to this combination. For example, the attention-drawing operation pattern may be any appropriate combination of various illumination direction angles.

Also, in the exemplary embodiment described above, such an example is described that the number of operations in the attention-drawing operation pattern is four. However, the number of operations is not limited to this number. The number of operations may be one to three or five or more.

Also, in the exemplary embodiment described above, such an example is described that the number of operations has been set in advance. However, the present invention is not limited to this example. For example, the number of operations may be input by operation unit 16.

Also, in the exemplary embodiment described above, such an example is described that the attention-drawing operation pattern is set by the number of operations. However, the present invention is not limited to this example. For example, the attention-drawing operation pattern may be designed to repeat a specified operation pattern during a given specific period of time. In this case, it is preferable to configure that the specific period of time can be input by operation unit 16.

Also, in the exemplary embodiment described above, such an example is described that the attention-drawing operation pattern is set, for example, by inputting angle information by programming. However, the present invention is not limited to this example. For example, the attention-drawing operation pattern may be set by using a teaching function that stores an illumination direction angle of light-emitting unit 10 set by a human such as a photographer each time the illumination direction angle is changed.

Also, in the exemplary embodiment described above, such an example is described that light-emitting unit 10 emits light each time the illumination direction angle of light-emitting unit 10 is changed. However, the present invention is not limited to this example. For example, only the operation of changing the illumination direction angle of light-emitting unit 10 may be performed without emitting light. This makes it possible to prevent consumption of electrical energy stored in main capacitor 26.

Also, in the exemplary embodiment described above, such an example is explained that emission of light is executed in conjunction with each change of the illumination direction angle of light-emitting unit 10 to enhance the attention-drawing capability. However, the present invention is not limited to this example. For example, emission of light may be omitted at a part of illumination direction angles of light-emitting unit 10 in an attention-drawing operation pattern. Further, as described above, only the operation of changing the illumination direction angle may be executed without emitting light.

Also, in the exemplary embodiment described above, such an example is explained that light-emitting unit 10 of strobe device 2 emits light at each shooting. However, the present invention is not limited to this example. That is, decision on whether to allow light-emitting unit 10 of strobe device 2 to emit light may be artificially made depending on photographing conditions or by a photographer. Accordingly, even if light is emitted by light-emitting unit 10 in an attention-drawing operation, strobe light may not necessarily be emitted at the time of shooting. This makes it possible to draw the subject's attention even when illumination is not necessary depending on the circumstances.

Also, in the exemplary embodiment described above, such an example is explained that the angle of vertical direction B is fixed and only the angle of horizontal direction F is changed to set an illumination direction angle of light-emitting unit 10 in each attention-drawing operation pattern. However, the present invention is not limited to this example. For example, the attention-drawing operation pattern may be such a pattern that both of the angle in vertical direction B and the angle in horizontal direction F are changed. Alternatively, the attention-drawing operation pattern may be such a pattern that the angle of light-emitting unit 10 may be set by changing only the angle in vertical direction B. This makes it possible to draw the subject's attention more effectively.

Also, in the exemplary embodiment described above, such a configuration example is explained that the attention-drawing operation pattern has been set in advance. However, the present invention is not limited to this configuration. For example, strobe device 2 may be configured such that control unit 15 of strobe device 2 determines attention-drawing operation patterns irregularly (at random).

Also, in the exemplary embodiment described above, such an example is explained that the angle of light-emitting unit 10 is controlled by using an absolute angle in vertical direction B detected by vertical direction angle detection unit 22 and an absolute angle in horizontal direction F detected by horizontal direction angle detection unit 23. However, the present invention is not limited to this example. For example, the angle of light-emitting unit 10 may be controlled by relatively changing the angles of light-emitting unit 10 in vertical direction B and horizontal direction F depending on control amounts of vertical direction drive unit 20 and horizontal direction drive unit 21 or driven amounts of vertical direction variable mechanism 18 and horizontal direction variable mechanism 19. It is possible to eliminate vertical direction angle detection unit 22 and horizontal direction angle detection unit 23. As a result, it is possible to reduce cost of the strobe device and the imaging device 1.

Also, in the exemplary embodiment described above, such an example is explained that the angle change of light-emitting unit 10 and light emission are used to call the subject's attention in the attention-drawing operation. However, the present invention is not limited to this example. For example, a sound generator (for example, a speaker) may be provided on strobe main body 9 or light-emitting unit 10 to call the subject's attention, for example, by sound. Also, it would be needless to say that the angle change of light-emitting unit 10, light emission and sound may be appropriately combined.

As described herein above, a strobe device according to the present invention includes: a strobe main body; a light-emitting unit rotatably connected to the strobe main body; a variable mechanism capable of changing an angle of the light-emitting unit; a drive unit for driving the variable mechanism; and a control unit for controlling the drive unit, wherein the control unit has a mode of changing an illumination direction angle of the light-emitting unit regularly or irregularly before shooting.

With this configuration, the illumination direction angle of the light-emitting unit can be changed by changing the angle of the light-emitting unit relative to the strobe main body. When the control unit is in the mode of changing an illumination direction angle of the light-emitting unit regularly or irregularly (at random) before the imaging device performs shooting, the control unit is able to change the illumination direction angle of the light-emitting unit regularly or irregularly (at random). Accordingly, when the subject is a human or an animal, it is possible that the operation of the light-emitting unit catches the subject's eye and draws attention of the subject (for example, make the subject turn to the imaging device side). As a result, shooting the subject in this state makes it possible to photograph the subject with a vivid expression.

Also, according to the strobe device of the present invention, the mode may include an operation of allowing the light-emitting unit to emit light. This makes it possible to further enhance the capability of seeking the subject's attention.

Also, an imaging device according to the present invention may be equipped with the above-described strobe device. This makes it possible to realize an imaging device that can draw the subject's attention and photograph the subject with a vivid expression.

### INDUSTRIAL APPLICABILITY

The present invention is useful to a strobe device and an imaging device equipped with the strobe device which are required, when a subject to be photographed is a human or an animal, to draw the subject's attention at the time of shooting, and to photograph the subject in a proper state.

### REFERENCE MARKS IN THE DRAWINGS

1 imaging device
2 strobe device
3 photographing function unit
4 control device
5 display unit
6 operation device
7 peripheral interface
8 shutter
9 strobe main body
9a upper surface
9b lower surface
9c front surface
9d back surface
10 light-emitting unit
10a one surface
11 flash discharge tube
12 variable mechanism
13 drive unit
14 angle detection unit
15 control unit
16 operation unit
17 opening
18 vertical direction variable mechanism
19 horizontal direction variable mechanism
20 vertical direction drive unit
21 horizontal direction drive unit
22 vertical direction angle detection unit
23 horizontal direction angle detection unit
24 arithmetic unit
25 storage unit
26 main capacitor

1. A strobe device comprising:
a strobe main body;
a light-emitting unit rotatably connected to the strobe main body;
a variable mechanism capable of changing an angle of the light-emitting unit;
a drive unit for driving the variable mechanism; and
a control unit for controlling the drive unit,
wherein the control unit has a mode of changing an illumination direction angle of the light-emitting unit regularly or irregularly before shooting.

2. The strobe device according to claim 1, wherein the mode includes an operation of allowing the light-emitting unit to emit light.

3. An imaging device comprising the strobe device according to claim 1.

4. An imaging device comprising the strobe device according to claim 2.
